(19) United States
(12) Patent Application Publication
(10) Pub. No.: US 2001/0039522 A1
(43) Pub. Date: Nov. 8, 2001

(54) System and method for ordering products or services

(76) Inventor: Jason Frank Saxon, Mississauga (CA)

Correspondence Address: DINSMORE & SHOHL, LLP, 1900 CHEMED CENTER, 255 EAST FIFTH STREET, CINCINNATI, OH, 45202, US

(21) Appl. No.: 09/871,714

(22) Filed: Jun. 1, 2001

(30) Foreign Application Priority Data
Feb. 6, 2000 (CA) 2,310,589

(51) Int. Cl. G06F 17/60

(52) U.S. Cl. 705/30; 705/26

(57) ABSTRACT

An automated ordering system includes a central station and numerous subscriber stations, including customer and vendor stations, whose sales transactions are regulated by the central station. A communication link, such as the Internet, permits each station to transmit and receive requisitions, purchase orders, and invoices to an from the central station. Each remote stations uses its own internal item identification codes, preferably general ledger account codes, to identify products to be purchased or sold. The central station maintains a database identifying the codes used by each subscriber station and relating different codes used by other subscribing stations to identify similar products. A customer may transmit to the cental station a requisition for a product identified with the customer accounting code and specifying a particular vendor. Using its database, the central station composes a purchase order addressed to the specified vendor and identifying the required product with the vendor's code. The central station monitors the entire transaction, ultimately to the parties to a transaction, accounting data in the form of ledger entries that can be immediately incorporated into their respect accounting systems. In a similar manner, the ordering system can identify vendors who supply a product desired by a customer, and automatically transmit requests for quotation to the vendors.

### FIELD OF THE INVENTION

The invention relates generally to facilitating commercial transactions, and more specifically, to systems for automating ordering of products and services and for providing accounting data relating to such transaction.

### BACKGROUND OF THE INVENTION

Systems have been proposed to automate ordering of products or services and to simplify placing of purchase orders, rendering of invoices, and reporting of transaction information.

U.S. Pat. No. 5,694,551 issued on Dec. 2, 1997 to Doyle et al for an invention entitled “Computerized Integration Network for Channelling Customer Orders Through a Centralized Computer to Various Suppliers.” The prior system permits a customer to transmit orders for products to a central supplier. The central station completes the customer's order with inventory on hand, and, where required, transmits purchase orders to the central vendor's own suppliers, who may then ship products directly to the customer. The system records purchase orders, which are directed to the central supplier, and records invoices issued by the central supplier to customers and issued by other suppliers to the central supplier. Accounting reports are provided to customers and a third party suppliers respecting transactions.

The prior are system works primarily to the benefit of the central supplier who remains the principal vendor. It contemplates that a customer will order products directly from the central supplier using a catalogue provided by the central supplier and product codes specific to the central supplier. The prior art system does not serve a general means for handling orders between customers and vendors, and the accounting information provided by the system is coded to suit the central vendor, not the accounting systems operated by the other parties.

### SUMMARY OF THE INVENTION

In one aspect, the invention provides an automated ordering system. The system includes a central station which is responsible for coordinating transactions among remote customer and vendor stations. A communication link couples each remote station to the central station for transmission of data such as requisitions, purchase orders, requests for quotes, invoices, or accounting data respecting transactions effected through the central station. When the central station receives a request for an item from any customer station, it automatically transmits a corresponding purchase order or request for quotation to one or more vendor stations, as required. To that end, the central station maintains a database that contains the internal codes used by each remote station to identify items purchased or sold by the station and that relates such codes to different internal codes used by other remote stations for identical or similar items. As explained below, the internal codes are preferably linked to the general ledger codes used by customers and vendors to identify items in their respective accounting systems.

In response to a received requisition or request for quotation, the central station automatically extracts the customer's internal code for any item in issue. The central station retrieves from its database the internal codes used by the suppliers to identify the ordered products, and then composes and transmits to the suppliers a purchase order identifying the required items, the central station uses the customer's item codes and links to corresponding supplier codes to identify one or more suppliers who can meet the customer's requirements. The central station then composes requests for quotation addressed to each supplier and each identifying the items in issue with the suppliers internal codes.

A transaction preferably effected entirely through the central station, which records purchase orders, invoices and any confirmation required to complete a transaction. The central station may then periodically transmit accounting data to the remote stations respecting such transactions, using conventional prompts to encourage retrieval of the data. Using general ledger codes to identify items purchased and sold, the central station provides each party to a transaction with accounting entries (entries prepared according to generally accepted accounting principles) that can be incorporated directly into their respective accounting system. In essence, the system permits various purchasers and vendors to automate updating of their accounting systems.

Other aspects of the invention will be apparent from a description below of preferred embodiments and will be more specifically defined in the appendant claims.

### BRIEF DESCRIPTION OF THE DRAWINGS

The invention will be better understood with reference to drawings illustrating and ordering system embodying the invention in which:

FIG. 1 schematically illustrates a central processing stations and multiple remote station coupled to the central station;

FIG. 2 diagrammatically illustrates portions of a database maintained by the central station.

FIG. 3 schematically illustrates a central processing station and multiple remote stations coupled to the central station; and

FIG. 4 diagrammatically illustrates the system and method of the present invention as a flow chart.

### DESCRIPTION OF PREFERRED EMBODIMENTS

The present invention provides an automated system for ordering products and services from a variety of suppliers. In addition to facilitating transactions between customers and suppliers, the system automatically updates the accounting records relating to these transactions such that both the supplier's and the customer's records are updated as transactions are executed. The system also facilitates the execution of customer/supplier transactions by automating activities such as the creation of requests for quotations, quotations, purchase orders, and invoices. The system also stream lines operations such as shipping, the generation of management reports and the payment of invoices.

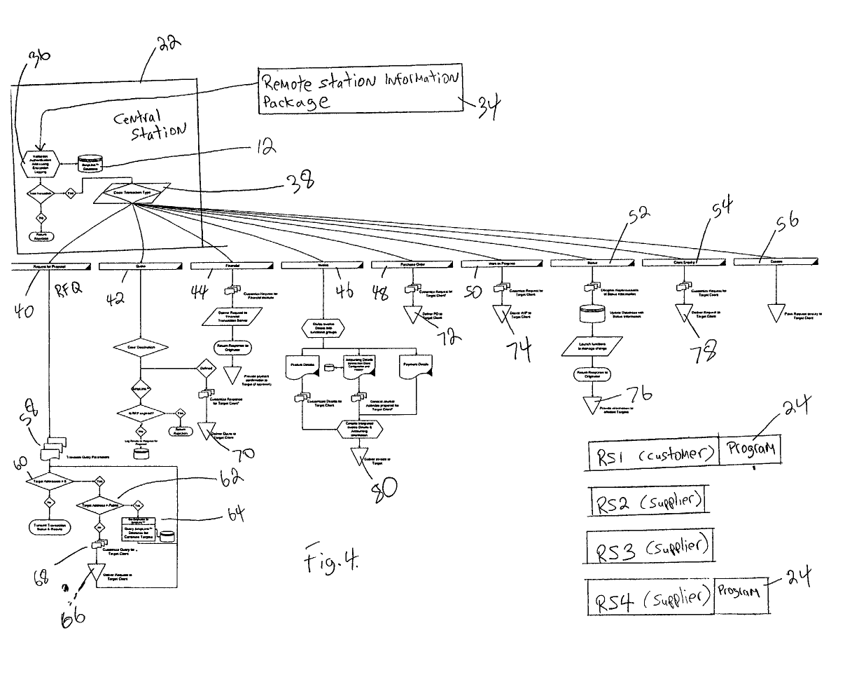

As shown generally in FIG. 3, the system of the present invention, shown generally as item 20, consists of a central station 22 and a multiplicity of remote stations RS1 to RS4, inclusive. While only four station have been shown for convenience of illustration, in practice, the system will comprise a far larger network of remote stations. The remote stations RS1-RS4 may be customer or vendor stations, and each may be a vendor of particular goods to the other stations RS1-RS4, and a customer with respect to others goods supplier by the other stations RS1-RS4. The stations CS and RS1-RS4 are coupled by a communication link, which may be the Internet, for transfer of data.

Each of the remote stations RS1 to RS4 may consist of any combination of a stand alone computer systems, networked computer systems or terminals, and network servers. Regardless of the size of the customer or supplier, each remote station shall have appropriate computer memory 26, processing power and access to an information storage device 28 (for example a hard drive) and a communications interface 30. Computer systems suitable for use as a remote station are commonly available.

Each of the remote stations RS1 to RS4 is pre-loaded with, or has access to, an accounting software program 24 which keeps track of and stores accounting information including accounts receivable, accounts payable, inventory, work in progress, item codes, and prices. Preferably, program 24 can generate, with the assistance of a computer user (not shown), standard accounting documents such as requests for quotations (RFQs), purchase orders, invoices, quotations, work in progress reports, and other accounting records as may be required. Also, program 24 should be adapted to interact with computer interface 30 to enable the program to exchange electronic messages back and forth with the central station 22 via communications line 32. Users may access program 24 in order to generate accounting documents and forward them electronically to central station 22 via interface 30 and communications line 32. As these accounting records are generated, the user has the option of adjusting the accounting records stored on hard drive 28 which relate to the records created. For example, if the user so wishes, software program 24 may adjust the accounts payable accounts stored on hard drive 28 when the user finalizes an invoice. Several accounting software programs are currently available which have these features, including programs such as Quick Books™, ACCPAC™, and numerous others. A suitable computer accounting program System 0110™ will be made available by the applicant.

It will be appreciated that in the event a user creates a purchase order (or other accounting document), he or she may be obliged to enter an item identification code into the document to identify the items being ordered. Since the business practices of different customers and suppliers vary, it is unlikely that the same items will be identified by the same identification codes by all suppliers and customers. Hence, a user at remote station RS1 may generate a purchase order for pencils which identifies the item being ordered as PEN/HB (signifying pencils having a hardness rating of HB). However, a supplier at remote station RS4 may identify pencils having a hardness rating of HB using a completely dissimilar code such as X123. In the event the purchase order generated at customer remote station RS1 be received by the supplier at remote station RS4, the item code PEN/HB may be meaningless and a transaction could not be executed. In this example, for a transaction to occur between the customer at station RS1 and the supplier at station RS4, the customer's item identification code must be matched with the suppliers item identification code. Central station 22 performs this matching function. Central station 22 comprises a computer system similar to the remote stations. As shall be described below, central station 22 is loaded with a database 12 which is adapted to enable transactions between customer and supplier remote stations by matching product identification codes.

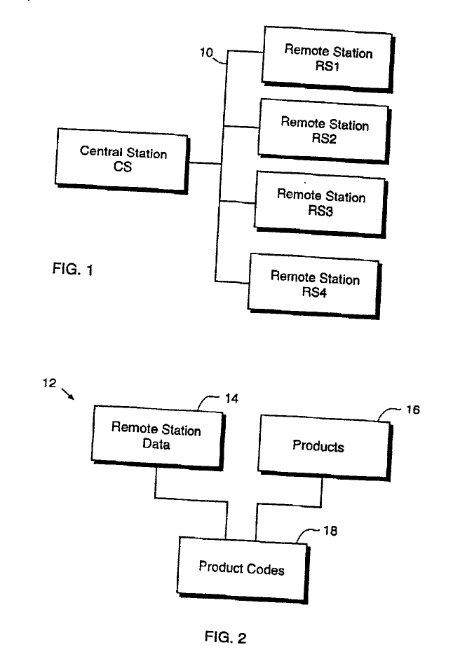

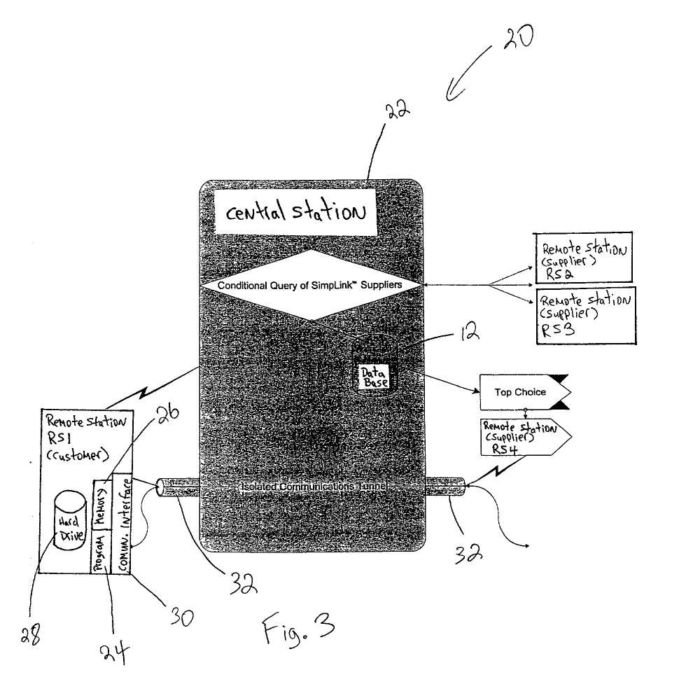

Referring now to FIG. 1, the central station CS maintains a database 12 of information regarding the remote stations RS1-RS4, which is schematically illustrated in FIG. 2. The database 12 may include a file 14 containing general information regarding the remote stations RS1-RS4, including communication data such as Internet addresses. The database 12 may also include a file 16 containing a general description or characterization of items involved in transactions between the various stations RS1-RS4, and a file 18 containing the product identification codes used by each remote station RS1-RS4 to identify products purchased and sold by the station. The files 14-18 may be linked in a conventional manner to permit retrieval of product codes corresponding to a particular item, and to permit retrieval of product codes of the remote stations RS1 -RS4 supplying such products.

A general description will be provided of how a customer station RS1 orders an item from a vendor sation RS4. The customer station RS1 includes a computer system and software that permits composition of a purchase order. The purchase order specifies the desired supplier, vendor stations RS4, using a vendor code unique within the system. It also identifies the item required with an internal code used by the customer stations RS I and retrieved from a database, such as an accounting system. The composed order is then transmitted to the central station CS. The central station CS uses the customer's item code to identify the record number of the product in file 16, and then uses the record number and vendor code to search the product code file 18 for the corresponding item code used by vendor station RS4. The central station CS them composes a purchase order incorporating the vendor's product code and data identifying the purchaser, customer station RS1, and transmits the purchase order to vendor station RS4.

If the transaction is standard, and the purchase price is known, the vendor station RS4 may simply prepare an invoice for transmission to the central station CS and arrange for delivery of the specified product to the customer station RS1. Alternatively, as a preliminary step, a price quote may be transmitted by the vendor station RS4 to the central station for relaying to the customer station RS1, and such confirmations as may be required to enable the transaction are exchanged through the central station. Once the transaction is complete, the central station provides accounting entries to each of the stations RS1, RS4. The entries delivered to the customer station RS1 ideally identify a general ledger asset or expense account identified with the customer's item code and credit a payable account in favour of the vendor. The entries delivered to the vendor station RS4 may debit a receivables account respecting the customer station RS1 and credit an inventory account identified with the item code of the vendor station. Each of the remote stations RS1, RS4 is preferably prompted on log-on to the central station CS to receive any pending journal entries and immediately record the entries in their respective accounting systems.

The system also permits a customer to seek quotes for a particular product from various vendors subscribing to the system. For example, the customer station RS1 may compose a request for quotation identifying a product with its own internal accounting code. The request is then transmitted to the central station CS where the internal code is extracted. Using the customer's internal product code, the central station CS searches the code file 18 for a corresponding record and in turn retrieves from the item file 16 a corresponding record identifying the product in issue. Using the corresponding record, the central station CS once again searches the product code file 18, this time locating all codes used by other stations to identify the product, and then isolates those codes used by vendor stations, for example, stations RS2 and RS3. The central station CS then composes requests for quotation addressed to each of the vendor stations RS2, RS3, incorporation the item code used internally by the particular vendor station, and transmitting the requests to the respecting vendor stations RS2, RS3. Each vendor station RS2, RS3 can immediately identify the required product since it receives its own internal code for the required product, and can immediately retrieve prices from its local database. Each vendor station RS2, RS3 then transmits an appropriate quotation to the central station CS, which in turn relays the quotations to the customer station RS1.

The advantage of this arrangement should be readily apparent. A subscriber identifies a required product using its internal product codes. The system then identifies subscribing vendors who supply the product, and can also specify the product in issue for each of the vendors, using the vendor's internal product codes. In practice, the central station CS can monitor transactions to extract product codes and continually update its database 12 to facilitate future transactions. In instances where product codes are not known to the central station CS or not properly linked to vendor or customer codes, the central station CS can request additional information to identify products or links, and update its database 12 accordingly.

Referring now to FIG. 3, the entire system and method of the invention shall now be disclosed in greater detail by way of an example transaction involving a customer purchasing an item from a supplier. A customer located at remote station RS1 may begin a transaction by logging on to accounting software program 24. If the customer notices that it is running out of a particular item (lets say pencils) the customer can prepare a request for quotation using software program 24. The request for quotation generated shall identify the item requested by the customer's item code (for example PEN/HB). The customer may choose to structure the request for quotation to be suitable for either one specific supplier or for several different suppliers. In the present example, the customer chooses to generate an RFQ intended to be transmitted to several different suppliers. Accounting software program 24 then transmits the RFQ to central station 22 via the communications interface 30 as an information package containing the customer's identification information and particulars of the RFQ such as the customer's product identification code (PEN/HB), the quantity, the delivery date and the like. This information package may be encrypted to enhance security.

Referring now to FIG. 4, the central station receives the RFQ in the form of an encrypted remote station information package 34. Information package 34 is transferred to a software subroutine 36 which performs validation, authentication, addressing, de-encryption and logging functions on the information package. The information package is then evaluated by subroutine 36 to determine if it is a valid transaction request. If not, then central station 22 returns the rejected information package to the remote station. If the information package is determined to be a valid transaction request, central station 22 forwards the processed information package to a software subroutine 38 which identifies the type of transaction being requested by the information package and sends it to one of software subroutines 40, 42, 44, 46, 48, 50, 52, 54 and 56. In this case, information package 34 is identified as an RFQ transaction request and is therefore sent to subroutine 40. Software subroutine 36 also extracts the customer's product identification code PEN/HB, and various information components in the RFQ such as the quantity, the price, the requested fulfilment date and the like.

In step 58 of subroutine 40, central station 22 matches the product identification code PEN/HB to the product identification codes used by the suppliers located at remote stations RS2, RS3 and RS4. In step 60 of subroutine 40, central station 22 then determines if any of the suppliers in database 12 supplies the products requested in the customers RFQ. If none of the suppliers carry the requested products, then a message is transmitted back to the customer. However, if there is at least one supplier who can respond to the RFQ, then central station 22 then determines if the RFQ was intended for broadcast to several suppliers (step 62). If the customer's RFQ was intended for only a single supplier, then at step 68 of subroutine 40, central station 22 customizes the customer's RFQ by converting the customer's product identification number to the supplier's product identification number. The central station then sends out the customized RFQ as a single information package 66 directed to a specif remote station. However, if the customer's RFQ was intended for broadcast to several suppliers, then using the extracted information components, central station 22 selects appropriate suppliers to quote on the RFQ. In step 64 of subroutine 40, the customer's RFQ information package is then customized for each supplier RS2, RS3 and RS4 which was selected and an information package tailored for each selected remote station is sent as information packages 66. For the purposes of this example, let us assume that suppliers RS2, RS3 and RS4 are sent information packages. These information packages are sent electronically to remote stations RS2, RS3 and RS4 through communications line 32 (see FIG. 3). The central station may send a confirming message back to customer station RS1.

The suppliers then receive the information packages electronically through the communications interface from central station 22. The suppliers then generate a quotation using the information contained in information packages 66. The quotation can be prepared either manually or automatically. If the accounting software loaded on to the supplier's computers are adapted to prepare the quotations automatically, then they will respond with a quotation. The quotation will of course incorporate the supplier's product identification code. This quotation is sent to the central station as a remote station information package containing a variety of information including the supplier's identification information, address, product identification code, price, payment terms, shipping terms, and any other information as may be required by the customer or supplier. Central station 22 then accepts the remote station information packages from each of the suppliers who respond and analyses them as it did information package 34. The information packages are then identified by subroutine 38 as quotations and are then routed to subroutine 42. In subroutine 42, the quotations from the suppliers are then customized by central station 22 to convert the suppliers product identification codes into the customers identification codes. These customized quotations are then sent electronically to the customer as information packages 70.

The information packages 70 received electronically by the customer may go directly into the customers accounting program 24. Alternatively, the supplier quotations may be received by the customer in the form of an e-mail message, or as an e-mail message with an attachment. The customer's computer may send an e-mail message back to central station 22 informing the central station that the quotations were received. The central station may then relay back to the suppliers that there quotations have been received by the customer. The customer can then view the quotations and either accept or reject them. If the customer rejects a quotation, then nothing further happens with the quotation. However, if the customer accepts a quotation, then the customer will create a purchase order for the specific supplier selected. In this example, let us assume that customer RS1 selects the quotation generated by supplier RS4 as the most attractive and decides to accept RS4's quotation. The customer then generates a purchase order corresponding to RS4's quotation using software program 24. Since the quotation is received in electronic form, accounting program 24 can easily incorporate the information contained in the quotation into the purchase order. The customer purchase order will again include the customer's product identification code (in this example PEN/HB). The customer's purchase order is then transmitted electronically to central station 22 as another information package.

The purchase order is received by central station 22 and then routed to subroutine 48 where it customized for receipt by supplier RS4 and electronically sent to the supplier as information package 72. The supplier receives the customized purchase order and can either accept it, reject it, or modify it. If the purchase order is rejected, a message may be transmitted to the central station for relay back to the customer informing the customer that the purchase order has been rejected. The rejection may have comments as to why the purchase order was rejected. The supplier can also modify the purchase order. Finally the supplier can accept the purchase order. Let us assume that the supplier accepts the purchase order, in which case the supplier can, using the supplier's accounting program 24, generate a fulfilment request or pro forma Invoice for its own internal departments in order to fulfil the purchase order. Again, the accounting program can automatically import relevant portions of the purchase order into the fulfilment request. The supplier can also generate an electronic message to the central station for relay back to the customer informing the customer that the purchase order has been accepted and that the order is being fulfilled.

The customer may generate, again from program 24, periodic requests for status reports which are electronically transmitted to central station 22. If the request for a status report is simple (for example, has the product been shipped), then the request for status report is routed to subroutine 54, where it is customized and sent to the supplier as information package 78. However, if the request is more complex, such as a detailed request for a work in progress report (WIP report), then it is routed to subroutine 50, where they are customized for receipt by the supplier and then sent electronically to the supplier as information package 74. The supplier can also generate periodic work in progress reports (WIP reports) summarizing the status of the order. These work in progress reports are generated by the supplier's accounting software 24 using the information stored in the supplier's accounting records database. The WIP reports can be transmitted electronically to central station 22 as another remote station information package. Again, the electronic WIP report is processed by central station 22 and routed to the appropriate subroutine, in this case subroutine 52, where it is customized for the customer and transmitted to the customer as electronic information package 76. The central station can update its accounting records on the status of the transaction in response to the WIP reports received by the supplier.

When the supplier completes the order for shipment, the supplier can use its accounting software 24 to generate shipping requisitions. For example, accounting program 24 can generate an electronic form which is transmitted to the shipping company. The electronic form can detail where the shipment is to be picked up, what the shipment is, where the shipment is to be sent and any other information as may be required. The shipping company can then attend to the shipment of the goods to the customer.

At some point, the supplier will generate an invoice for the fulfilment of the customer's purchase order. This invoice will be created by the supplier using the supplier's accounting program 24. The invoice will have various details such as payment terms, price, product identification codes, and other details as may be required. The accounting program automatically updates the supplier's accounting records by making appropriate adjustments to the accounts receivable and inventory accounts and any other accounts as may be required. The invoice is then electronically transmitted to central station 22 as another remote station information package. Central station 22 routes the invoice to subroutine 46. In subroutine 46, the information contained in the invoice is disassembled into product details, accounting details and payment details. The product and accounting details are then translated so that the supplier's product identification codes are translated into the customer's product identification codes. The translated product and accounting details are then combined with the payment details and compiled into a customized invoice which is electronically sent to the customer as information package 80.

When the invoice is received by the customer, the customer has a choice of payment methods such as payment right away, within 30 days, payment on deliver, depending on the particulars of the invoice. The customer's accounting software 24 automatically adjusts the accounting records to reflect the invoice received. For example, the accounts payable account is adjusted to reflect the invoiced amount. Again, since the invoice is received electronically, the customer's accounting program 24 can easily incorporate the data in the invoice to automatically update the accounting records with a minimum amount of data entry on the part of the customer's staff. The customer's accounting program 24 may also arrange for payment using pre-authorized wire transfers, credit cards, or automated cheque writing. If paper cheques are printed, then the customer will have to mail them to the supplier in a conventional fashion. In the event the supplier and customer are set up for electronic funds transfer, then the customer can use accounting program 24 to generate the appropriate bank authorizations records. When payment is made, the customer's accounting program 24 then updates the customer's accounting records appropriately.

Finally, the last step in this hypothetical transaction would be the receipt of the payment by the supplier. The receipt can be either a cheque received in the mail, in which case the supplier's accounting software will then have to be accessed manually to post the payment. Alternatively, if the payment was received via an electronic transfer there would be some electronic signal sent from the bank indicating that a payment had been made to one of the supplier's bank accounts. The supplier's accounting program 24, either automatically, or through the use of an operator, records the payment. The accounting program then automatically matches the payment to the invoice which was sent and adjusts the accounts receivables and other accounts accordingly.

While the preceding example started with the generation of an RFQ, it will be appreciated that any transaction can enter the system shown in FIG. 4 at any stage in the transaction. For example, the customer may choose to first issue a purchase order rather than an RFQ. In some cases, the supplier may, after receiving a paper purchase order from a customer, decide to send an electronic invoice to the customer by sending a remote station information package to central station 22.

The system is also capable of providing both customers and suppliers with periodic management reports. For example, should a customer request a management report detailing the status of an transaction or group of transactions, the customer may generate a request using the accounting software program 24 and forward same to central station 22. Central station 22 will then route the request to the appropriate subroutine, in this case subroutine 54, which will in turn customize it for receipt by the appropriate suppliers and transmit it electronically. The responses received by central station 22 are then customized for receipt by the customer. Likewise, information reports may be requested by the supplier's sales department, in which case the supplier will generate an information request using program 24 and forward same to central station 22. Central station 22 will then route the request to subroutine 54 and appropriately customized information packages will be transmitted to the supplier's customers. The responses will then be customized and relayed back to the supplier.

It will be appreciated that a particular embodiment of the invention has been described and that modifications may be made therein without departing from the spirit of the invention or necessarily departing from scope of the appended claims.

The embodiments of an invention in which an exclusive property or privilege is claimed are defined as follows:

1. An automated ordering system comprising:
a. A central station;
b. A multiplicity of remote stations including customer stations and vendor stations, each of the remote stations comprising a database of internal codes for items which are different from internal codes of others of the remote stations for such items;
c. A communication link between each of the remote stations and the central station for transmission of data;
d. The central station comprising ordering relaying means for receiving an order for items from any one of the customer stations and transmitting a corresponding purchase order to one or more of the vendor stations, the order relaying means comprising:
i. A database containing the internal codes used by each of the remote stations to identify items and relating the internal codes of each of the remote stations to different internal codes of others of the remote stations for such items; and,
ii. Software cooperating with the database to automatically insert into the corresponding order transmitted to each of the one or more vendor stations the internal item code of the vendor station corresponding to the internal item code of the customer station.

2. The system of claim 1 in which the internal codes are general ledger codes associated with accounting systems used by the remote stations and in which the central station transmits to each of the station accounting entries incorporating its general ledger codes.

3. An automated transaction facilitating system comprising;
(a) a relay station operatively coupled to a communications network;
(b) a plurality of remote stations including vendor stations and customer stations, each of the remote stations having a computer system adapted to generate and receive electronic transaction documents having item identification codes, the item identification codes for the same items being different for different remote stations, each of the remote stations being adapted to transmit and receive the electronic transaction documents to and from the relay station via the communications network;
(c) the relay station having a database containing the item identification codes used by the remote stations and a translation program cooperating with the database to automatically translate the product identification codes of different remote stations, the translation program adapted to translate and relay electronic transaction documents between remote stations.

4. The system of claim 3 wherein the translation program translates the electronic transaction documents of different remote stations by replacing the product identification code used by the remote station transmitting the electronic transaction document with the product identification code used by the remote station intended to receive the electronic transaction document.

5. The system of claim 3 wherein the remote stations each have an accounting program adapted to generate and receive the electronic transaction documents.

6. The system of claim 5 wherein the accounting program includes a database of accounting records for that remote station and wherein the accounting program is adapted to automatically update the accounting records upon receipt and transmission of an electronic transaction document.

7. The system of claim 4 wherein the remote stations each have an accounting program adapted to generate and receive the electronic transaction documents.

8. The system of claim 7 wherein each accounting program includes a database of accounting records for the corresponding remote station and wherein each accounting program is adapted to automatically update the accounting records upon receipt or transmission of the electronic transaction documents.
